(19) United States
(12) Patent Application Publication
(10) Pub. No.: US 2016/0145549 A1
(43) Pub. Date: May 26, 2016

(54) SYSTEM AND METHOD FOR HAZARDOUS DRUG SURFACE CLEANING

(71) Applicant: University of North Carolina at Chapel Hill, Chapel Hill, NC (US)

(72) Inventors: William Zamboni, Chapel Hill, NC (US); Tom O'Neill, Potomac, MD (US); Stephen Eckel, Chapel Hill, NC (US)

(73) Assignee: University of North Carolina at Chapel Hill, Chapel Hill, NC (US)

(21) Appl. No.: 15/002,570

(22) Filed: Jan. 21, 2016

Related U.S. Application Data
(62) Division of application No. 14/215,855, filed on Mar. 17, 2014.
(60) Provisional application No. 61/788,426, filed on Mar. 15, 2013.

(51) Int. Cl. C11D 17/04; C11D 11/00; C11D 7/32; B08B 1/00; C11D 7/26

(52) U.S. Cl. CPC C11D 17/049; B08B 1/006; C11D 7/261; C11D 7/3209; C11D 11/0064

(57) ABSTRACT

The present invention relates to a method of cleaning a surface contaminated with a hazardous drug product involving cleaning in succession with a quaternary ammonium solution and an isopropyl alcohol solution.

This application is a divisional of U.S. application Ser. No. 14/215,855 filed on Mar. 17, 2014, which claims the benefit of and priority to U.S. provisional application No. 61/788,426 filed on Mar. 15, 2013. All applications are incorporated in their entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method and system for cleaning surfaces. More particularly the present invention relates to a method and system for the removal of hazardous drug products from surfaces.

2. Description of Related Art

The ability to clean environmental surfaces of contamination is an important job in many situations from food preparation to hazardous situations. Each situation has various particular issues for contamination removal and the systems for cleaning vary with the contamination to be removed.

Most surface cleaning in work and other environments is to sanitize the area to remove viral and bacterial contamination under conditions where the contamination will harm the person using the environment or something prepared or worked on in the environment like food preparation or the like. Sanitization concentrates on killing the virus or bacteria and not on cleaning, though removal of the contamination is a form of cleaning. Dead bacterial left behind do not usually pose much, if any, of a threat. One of the most difficult areas of contamination is in areas where drugs and related hazardous drug products are utilized. In these situations the issue is not bacteria or virus killing, it is the complete removal of products that even minute quantities might cause severe toxicities, injury or even death to the subject or person exposed to the contamination.

Since hazardous drugs are toxic, direct bodily contact thereto, or exposure to even micro-quantities of the drug, considerably increases the risk of developing health fatalities such as skin cancer, leukemia, liver damage, malformation, miscarriage and premature birth. Such exposure can take place when a drug containing receptacle, such as a vial, bottle, syringe, and intravenous bag, is subjected to overpressure, resulting in the leakage of fluid or air contaminated by the hazardous drug to the surroundings. Exposure to a hazardous drug also results from a drug solution remaining on a needle tip, on a vial or intravenous bag seal, or by the accidental puncturing of the skin by the needle tip. In addition, surface contamination can result from the synthesis, production, packaging, weighing, compounding of hazardous drugs, and the like. This is especially true for those working in healthcare situations or laboratories.

### BRIEF SUMMARY OF THE INVENTION

The present invention relates to the discovery that a two part cleaning system cleans up hazardous drug surface contamination better than existing cleaning systems and methods. By cleaning first with a quaternary ammonium solution followed in successive order by a isopropyl alcohol and water solution hazardous drug products are cleaned up without leaving detectable residues form the surfaces.

In one embodiment, the present invention relates to a method of cleaning a surface contaminated with a hazardous drug product comprising:
a) wiping the surface a first time with a first solution of an quaternary ammonium solution having a concentration of from about 0.5% to about 5.0%; and
b) wiping the surface a second time in succession with a second solution of water and isopropyl alcohol; the isopropyl alcohol comprising at least about 50% of the solution.

In another embodiment, it relates to a system for cleaning a surface contaminated with a hazardous drug product comprising a first towelette impregnated with a solution of a quaternary ammonium solution having a concentration of from about 0.5% to about 5.0% and a second towelette impregnated with a water and isopropyl alcohol solution the isopropyl alcohol comprising at least about 50% of the solution.

In yet another embodiment, it relates to a kit of parts for cleaning a surface contaminated with a hazardous drug product comprising:
a) a first solution of an quaternary ammonium solution having a concentration of from about 0.5% to about 5.0%;
b) a second solution of water and isopropyl alcohol, the isopropyl alcohol comprising at least about 50% of the solution; and
c) instructions for cleaning the contaminated surface with each of the solutions in succession.

### DETAILED DESCRIPTION OF THE INVENTION

While this invention is susceptible to embodiment in many different forms, there will herein be described in detail specific embodiments, with the understanding that the present disclosure of such embodiments is to be considered as an example of the principles and not intended to limit the invention to the specific embodiments shown and described. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment” “certain embodiments” and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “cleaning” refers to the removal of contamination on a selected surface. In particular, it relates to removal of hazardous drugs, and hazardously related products (e.g. breakdown products and products used to make the hazardous decay) from the surface. In general, removal relates to removal of such contaminants to a degree that all detectable residues of a hazardous drug product are removed. Surfaces include but are not limited to countertops, equipment, walls, floors, and essentially any solid surface that is compatible with the ingredients being used to clean the surface.

As used herein the term “surface” refers to any solid surface that one would encounter hazardous drug contamination. For example, in drug manufacture, drug discovery and drug dispensing, counters, walls, equipment, cabinets and the like in the environment may need to be cleaned of drug contamination. This is especially true where Federal regulation dictates certain levels of cleanliness to operate a business.

The term “towelette” as used herein, generally includes any napkin, paper towel, tissue, fabric, doth, or similar material, or any other object suitable for applying the solutions of the present invention to the surface to be cleaned. The towelette can be reusable or disposable as desired. A disposable towelette usually refers to low cost materials designed for a single use, such as made with paper or very inexpensive doth or other materials since all materials can be disposed of. The material must be absorbent enough to impregnate the towelette with each of the solutions. Therefore, the material for each solution can be the same or can be different depending on the characteristics desired. Since it is intended for dean-up of a hazardous drug product, it will need to be capable of having the product stuck or be absorbed in slurry or solution onto the surface of the towelette before disposal. The size of the towelette is, by choice, the size of the area to be cleaned in, and therefore is within the skill in the art if the towelette is small or large in view of the disclosure herein.

Medical, nursing, pharmacy and laboratory personnel that are involved in the preparation, use and administration of hazardous drugs suffer the risk of being exposed to the drugs or the compositions used in the manufacture and delivery of drugs, which may escape to the surrounding surfaces and thus come into contact with personnel utilizing the surfaces or coming in contact with them. As used herein, a “hazardous drug product” is any material the contact with which may constitute a health hazard. This includes the drugs themselves the precursors, side products, solvents utilized therewith and the like connected with the drugs themselves, Illustrative and non-limitative examples of such drugs include, inter alia, cytotoxins, antiviral drugs, chemotherapy drugs, antibiotics, and radiopharmaceuticals, such as herceptin, cisplatinum, fluorouracil, leucovorin, taxol, metatroxat, gemzar, cyclophosphamide, Cytoxan, and neosar, or a combination thereof, in a liquid or solid state. Other examples of hazardous drug products include docetaxel, paclitaxel, 5-fluorouracil, cyclophosphamide, ifosfamide and cisplatin. Contaminated then refers to the hazardous drug product being on a surface where someone can come into contact with the drug product.

The system comprises a first cleaning and a second cleaning. In this system, a process whereby the surface is first cleaned with a solution of a quaternary ammonium solution having a concentration of from about 0.5% to about 5.0%. The solution, in other embodiments, can be 1 to 3% or the like. In other embodiments the solution can be impregnated on a reusable or disposable towelette. Next, after the first cleaning, a second cleaning in succession is performed. In succession refers to a time period right after the first cleaning such that there is little or no time for the surface to be recontaminated such as mere seconds but within a reasonable time period. The second cleaning is performed with a second solution of water and isopropyl alcohol, the isopropyl alcohol comprising at least about 50% of the solution. The towelettes or whatever is utilized to apply the solutions can be disposed of in hazardous waste containers or the like or reutilized after appropriate cleaning. The solutions can be delivered for application by a user to a towelette or can be impregnated onto a towelette for use.

In one embodiment, there is a kit of parts wherein the first and second solution are packaged or otherwise delivered, along with instructions for use in cleaning a hazardous drug product from a surface by utilizing a first wiping and a second wiping with each of the solutions in succession. In one embodiment the quaternary ammonium solution is utilized to wipe the surface first.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description. Consequently, while the present invention has been described with reference to particular embodiments, modifications of structure, sequence, materials, and the like, apparent to those skilled in the art still fall within the scope of the invention as claimed by the applicant.

1. A method of cleaning a surface contaminated with a hazardous drug or hazardous drug related products comprising:
a) wiping the surface a first time with a first solution of an quaternary ammonium solution having a concentration of from about 0.5% to about 5.0%; and
b) wiping the surface a second time in succession with a second solution of water and isopropyl alcohol the isopropyl alcohol comprising at least about 50% of the solution.

2. The method according to claim 1 wherein each of the first solution and second solution are impregnated on to a towelette.

3. The method according to claim 2 wherein the towelette is disposable.

4. The method according to claim 1 wherein the hazardous drug product is at least one of docetaxel, paclitaxel, 5-fluorouracil, cyclophosphamide, ifosfamide and cisplatin.

5-7. (canceled)
